(19) United States
(12) Patent Application Publication
(10) Pub. No.: US 2018/0347858 A1
(43) Pub. Date: Dec. 6, 2018

(54) Combination Solar and Combustion Heater

(71) Applicant: ThermoLift, Inc., Stony Brook, NY (US)

(72) Inventors: Peter Hofbauer, West Bloomfield, MI (US); Todd A. Kappauf, Dearborn, MI (US)

(21) Appl. No.: 16/058,846

(22) Filed: Aug. 8, 2018

Related U.S. Application Data
(63) Continuation-in-part of application No. 14/435,459, filed on Apr. 14, 2015, now abandoned.
(60) Provisional application No. 61/715,341, filed on Oct. 18, 2012.

(51) Int. Cl. F24S 20/40; F24S 10/70; F24S 23/71; F24S 50/40

(52) U.S. Cl. CPC F24S 20/40; F24S 10/744; F24S 2020/23; F24S 50/40; F24S 23/71

(57) ABSTRACT

Substituting a solar concentrator for a conventional burner for heating is desirable. However, the sun's energy is diurnal and cannot be counted upon even during daylight hours. To ensure heating is available, a combustor can be provided. According to the present disclosure, a heat exchanger element of the heater assembly is directly acted upon by solar rays via a solar concentrator and by combustion. The heat exchanger also acts as the combustion holder when the burner supplements or supplants the solar radiation. Fuel provided to the outside of the heat exchanger is adjusted based on the demanded for heating and the amount of insolation (rate of delivery of solar radiation) achieved via the solar concentrator. The heat exchanger can be part of a conventional heater or a heat pump for heating water or air.

### FIELD

The present disclosure relates to a heater that combines a solar concentrator and a burner.

### BACKGROUND

It is desirable to supplant nonrenewable resources, such as natural gas, with renewable sources such as solar. Solar, however, is diurnal. Either a large storage system is provided to store the solar energy for use at times when solar is unavailable or the solar is supplemented. It is known to use a burner to supplement solar, such as is described in U.S. Pat. No. 4,328,791, in which a gas-fired burner provides thermal energy only in the event that the solar heating is insufficient. In '791, a water tank is provided with supply and return connectors for circulating water from the tank to a solar collector and back to the tank. A gas heater is disposed within the upper half of the tank. And a solar collector is located remotely with water from the water tank circulated through the solar collector via supply and return lines, which are subject to heat losses. The solar collector and the burner heating devices are displaced from each other. It is desirable to have a more simplified heating system that uses solar energy, combustion energy, or a combination of solar and combustion.

### SUMMARY

To provide at least one desired feature, a heater assembly is disclosed that includes: a window having an outer surface and an inner surface, a solar concentrator having a collection area many times greater than an area of the window, a heat exchanger that is arranged closer to the inner surface of the window, and a fuel-and-air delivery chamber defined by the inner surface of the window, a first surface of the heat exchanger, and a side wall of the delivery chamber with an inlet for fuel and air defined in the side wall of the delivery chamber. Most of the sun rays that impact the solar concentrator are reflected onto the outer surface of the window.

The heat exchanger comprises at least one tube arranged in a spiral with a distance between adjacent tubes displaced less than equal to a quench distance of the fuel and air. The heat exchanger may be alternatively configured in any suitable formation.

The heater assembly also includes an exhaust chamber defined by a second surface of the heat exchanger, a side wall of the exhaust chamber, and a bottom wall with an outlet for exhaust gases defined in one of the side wall and the bottom wall of the exhaust chamber and an ignitor disposed in the exhaust chamber. The assembly further includes: a fuel supply duct coupled to an inlet of the fuel-and-air delivery chamber, an air supply duct coupled to the inlet of the fuel-and-air delivery chamber, a fuel valve disposed in the fuel supply duct, and an electronic control unit electronically coupled to the fuel valve and the ignitor.

The heat exchanger has at least one tube adapted to carry a working fluid, the tube is arranged in a spiral, and the tube has an inlet and an outlet. A temperature-measuring device is disposed in the outlet of the tube. An electronic control unit (ECU) is electronically coupled to the temperature measuring device and the fuel valve. The ECU controls the fuel valve based on the temperature at the outlet of the tube.

The window and the heat exchanger are substantially flat and parallel to each other. In one embodiment, the solar concentrator has a concave reflective parabolic ring adapted to reflect incoming solar rays onto the window, a convex reflective parabolic disk disposed opposite the upper surface of the window, and a concave reflective parabolic bowl disposed inside the reflective parabolic ring. The parabolic bowl is adapted to reflect incoming solar rays onto the parabolic disk and the parabolic disk is adapted to reflect incoming solar rays from the parabolic bowl onto the window.

Also disclosed is a heat assembly that includes a solar concentrator, a heat exchanger comprising at least one tube arranged in a spiral, and a window arranged between the solar concentrator and the heat exchanger. The at least one tube is adapted to conduct a working fluid. The solar concentrator is arranged to direct the sun's rays onto the heat exchanger. The heat exchanger is adapted to stabilize combustion at an outer surface of the heat exchanger when provided a combustible mixture of air and fuel and after combustion has been initiated. The heat exchanger is disposed within a chamber that is defined by: a window arranged substantially parallel to the heat, a side wall, and a bottom wall and the chamber is separated by the heat exchanger into a fuel-and-air delivery chamber and an exhaust chamber.

The fuel-and-air delivery chamber defines a fuel-and-air inlet. The exhaust chamber defines an exhaust outlet. The exhaust chamber has an ignitor disposed therein.

At least one tube includes a first tube arranged in a first spiral with an inlet at the center of the first spiral and an outlet at the periphery of the first spiral and a second tube arranged in a second spiral with an inlet at the center of the second spiral and an outlet at the periphery of the second spiral. The first and second spirals are entwined and the outlets of the first and second tubes are arranged substantially diametrically opposed from each other. Throughout the spiral, a distance between adjacent tubes in the spiral is less than a quench distance.

The solar concentrator is substantially parabolic. The assembly further includes: a positioning system to move one of: a mirror of a heliostat, the solar concentrator, and the heater assembly so that available rays from the sun are directed into the solar concentrator substantially parallel to a central axis of the solar concentrator, a fuel delivery system having a valve to meter an amount of fuel provided to the fuel-and-air delivery chamber, an air delivery system for metering air provided to the fuel-and-air delivery chamber, and an electronic control unit electronically coupled to the valve, the ignitor, and the positioning system.

Also disclosed is a method to operate a heater assembly having a solar concentrator and a heat exchanger adapted to stabilize combustion. One of: a heliostat proximate the solar concentrator, the solar concentrator, or the heater assembly is positioned to cause solar rays to impact the heat exchanger. The method further includes determining a present heating demand and supplying fuel and air to the heat exchanger when the solar energy is insufficient to provide the heating demand. The method further includes actuating the ignitor when a temperature of the heat exchanger is below the ignition temperature of the fuel and air proximate the heat exchanger.

The method may further include adjusting the flow rate of fuel and air based on the desired heating demand.

When the fuel flow is very low, it may be difficult to sustain combustion and it indicates that the insolation in insufficient to meet demand. Herein, insolation means the rate of delivery of solar radiation to the heat exchanger. The method further includes determining whether the fuel valve is nearly turned off. If so, the fuel valve is commanded to close. In an embodiment with a heliostat, the method includes positioning a mirror of the heliostat substantially parallel to the heat exchanger when it is determined that it is night time.

Also disclosed is a heater assembly that has a chamber in which a heat exchanger is disposed. The heat exchanger has a tube having multiple bends with adjacent sections of the tube have a gap that is than a predetermined width. A working fluid flows within the tube of the heat exchanger. An outer surface of the tube of the heat exchanger is provided energy by incident solar radiation. The outer surface of the tube of the heat exchanger is provided at least two reactants. The reactants react proximate gaps between adjacent sections of the tube of the heat exchanger. The reaction between the two reactants is an exothermic reaction liberating thermal energy.

The reactants are fuel and air in some embodiments.

Prior systems have provided a fuel-fired burner as a backup to solar energy. The present disclosure improves on prior systems by having the burner and the solar concentrator acting upon the same element thereby avoiding additional components and sources for loss.

The present system readily allows for the burner to supplement the solar energy when the solar insolation is insufficient for the desired purpose.

### BRIEF DESCRIPTION OF THE DRAWINGS

FIG. 1 is an illustration of a heater according to an embodiment of the present disclosure;

FIG. 2 is a plan view of the heat exchanger of FIG. 1;

FIG. 3 is a plan view of the solar concentrator of FIG. 1;

FIG. 4 is an illustration of a heliostat configuration to reflect rays into a solar concentrator;

FIG. 5 is an illustration of the burner and an electronic control unit to control the burner;

FIG. 6 is an embodiment of a solar concentrator with the incident solar rays vertical;

FIG. 7 is the solar concentrator of FIG. 6 in which the incident solar rays are displaced by an angle with respect to vertical;

FIG. 8 is an illustration of a Vuilleumier heat pump, an example of one device that can be combined with the heater disclosed herein;

FIG. 9 is a flowchart illustrating one embodiment of operation of the heater; and

FIG. 10 is an illustration of the combustion zone occurring between adjacent tubes of a heat exchanger.

### DETAILED DESCRIPTION

As those of ordinary skill in the art will understand, various features of the embodiments illustrated and described with reference to any one of the Figures may be combined with features illustrated in one or more other Figures to produce alternative embodiments that are not explicitly illustrated or described. The combinations of features illustrated provide representative embodiments for typical applications. However, various combinations and modifications of the features consistent with the teachings of the present disclosure may be desired for particular applications or implementations. Those of ordinary skill in the art may recognize similar applications or implementations whether or not explicitly described or illustrated.

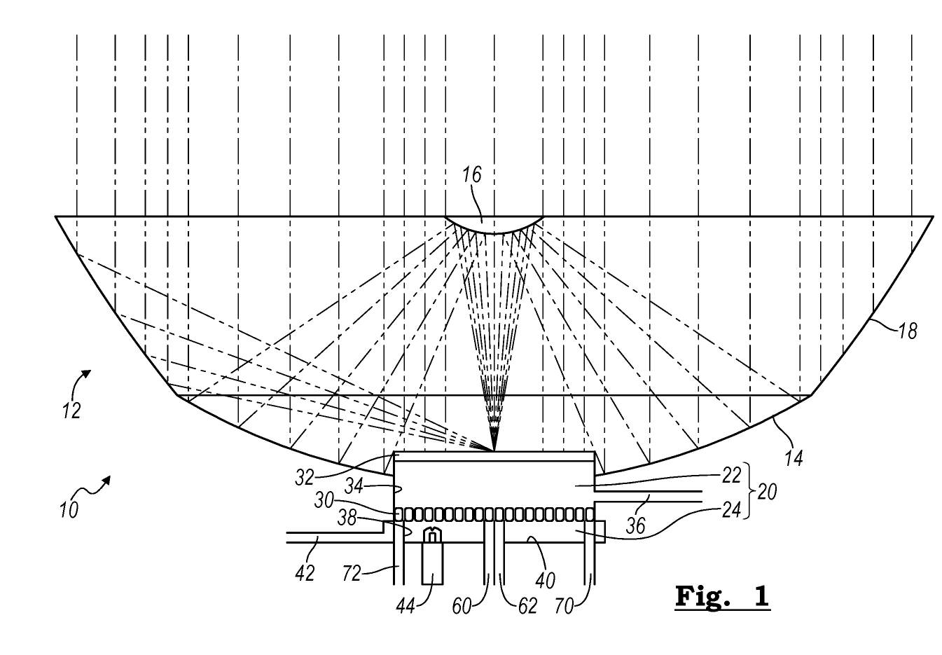

A heater assembly 10 is shown in FIG. 1. Heater assembly 10 has a solar concentrator 12. Solar concentrator 12 has a concave reflective parabolic bowl 14 portion that reflects the sun's parallel rays to a convex reflective parabolic disk 16 portion. Disk 16 reflects the sun's rays downwardly. Solar concentrator 12 also includes a convex reflective parabolic ring 18.

Heater assembly 10 also includes a burner that is enclosed in a chamber 20. Chamber 20 has two portions: a fuel-and-air delivery chamber 22 and an exhaust chamber 24 that is separated by a heat exchanger 30. Fuel-and-air delivery chamber 22 is defined by a window 32, heat exchanger 30, and a side wall 34. Defined in side wall 34 is a fuel-and-air inlet 36. Exhaust chamber 24 is defined by heat exchanger 30, a side wall 38 and a bottom wall 40. Products of the combustion of the fuel and air exits exhaust chamber 24 via an outlet 42 defined in side wall 38. Alternatively, outlet 42 is installed in bottom wall 40.

Referring now to FIG. 10, a cut through two adjacent tubes 30a and 30b of heat exchanger 30 (shown more fully in FIG. 1) is shown. Fuel and air are supplied to the heat exchanger with a portion of the fuel-and-air flow 250 passing between a gap 260 between adjacent tubes 30a and 30b. When the system has been ignited and there is combustion in gap 260, the fuel and air flowing into gap 260 reacts in zone 252, thereby releasing thermal energy to tubes 30a and 30b. The unburned fuel and air that flow into the gap ignites as it enters into the gap 260. Exhaust products or exhaust gases, illustrated as arrow 254, exit zone 252. Any suitable fuel can be used. As one non-limiting example, the fuel is natural gas that reacts with air and forms carbon dioxide and water. The exhaust products, in such case, are carbon dioxide, water, nitrogen from the air that exits substantially unreacted, any oxygen not reacted during combustion, and other trace species.

Referring back to FIG. 1, in one embodiment, window 32 is a quartz crystal due to quartz's desirable optical properties. Any suitable material that is highly transparent to visible and UV light, substantially opaque to infrared, and withstands higher temperatures due to the proximity to the burner is a suitable alternative.

The sun's rays that hit parabolic bowl 14 reflect toward parabolic disk 16 and are directed onto window 32 and transmitted to heat exchanger 30. The sun's rays that hit parabolic ring 18 are directed onto window 32 and transmitted to heat exchanger 30. The embodiment shown in FIG. 1 is one non-limiting example configuration.

Fuel and air supplied through inlet 36 are drawn into air-and-fuel delivery chamber 22 through gaps in heat exchanger 30 into exhaust chamber 24. An ignitor 44 can be used to start combustion. After combustion is established, combustion occurs at the heat exchanger 30. Gaps in heat exchanger 30 are carefully sized to be smaller than the quench distance. By ensuring the gaps are sufficiently small, flash back into fuel-and-air delivery chamber 22 is prevented.

Quench distance is commonly defined as a width or a diameter through which a flame will not propagate. The quench distance depends on the geometry, (e.g., whether a slot or a tube) and the stoichiometry of the fuel-air mixture, primarily, with other secondary effects such as fuel type, the material around the gap, and temperature. For the present situation, the quench distance is determined for the operating condition anticipated which yields the smallest quench distance and is on the order of 0.5 mm. The gaps between adjacent tubes are spaced such that they are smaller than the determined quench distance throughout heat exchanger 30.

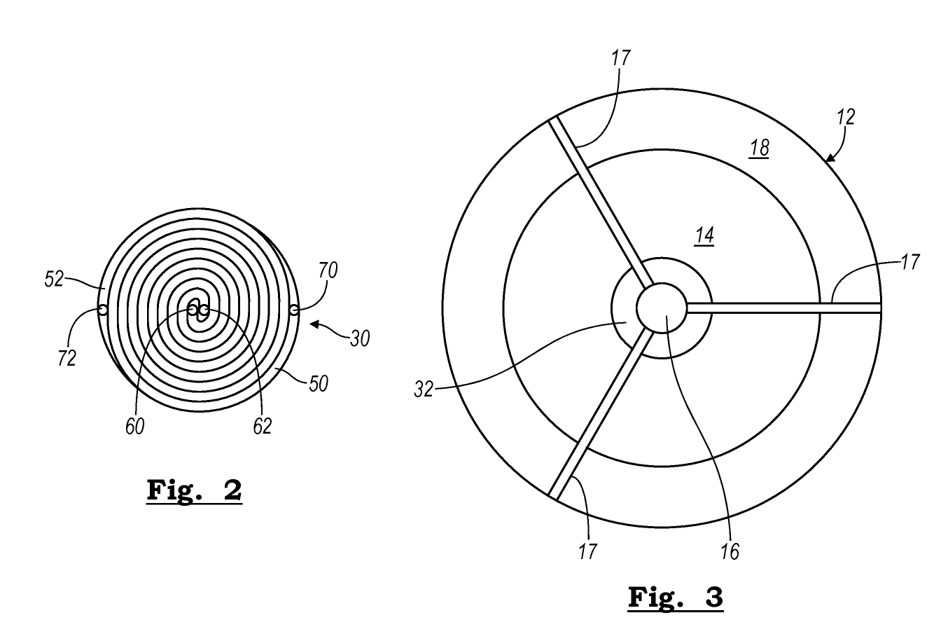

Heat exchanger 30, shown in plan view in FIG. 2, has two tubes 50 and 52 that are entwined in a spiral. Inlets 60 and 62 and outlets 70 and 72 are provided to tubes 50 and 52, respectively. The embodiment of heat exchanger 30 in FIGS. 1 and 2 is one non-limiting example showing two outlets to provide two supplies of heated working fluid evenly distributed. Alternatively, only one tube could be used. Or, more tubes could be used to branch out the heated working fluid more.

In FIG. 3, a plan view of solar concentrator 12 is shown. Parabolic ring 18 surrounds parabolic bowl. Window 32 is at the center. Parabolic disk 16 is supported by arms 17. Such a configuration provides a more compact solar concentrator than if parabolic ring were to extend further into the center of the device. The embodiment shown in FIGS. 1 and 3 is one non-limiting example of a solar concentrator. Other configurations could be substituted.

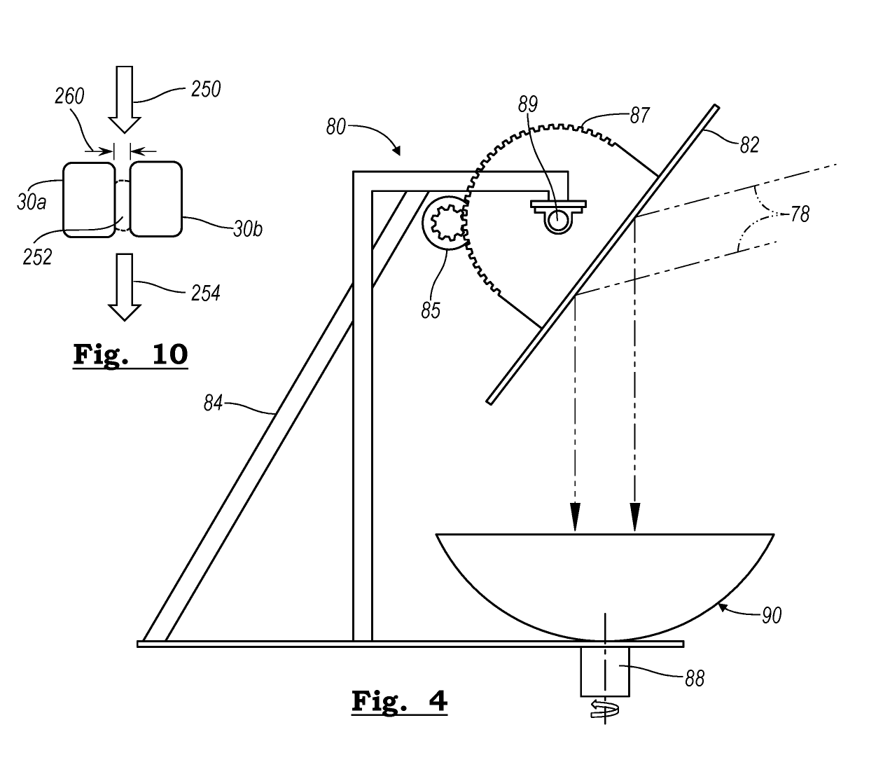

In FIG. 1, parallel rays are shown entering solar concentrator 12 in a vertical direction. However, the sun is directly overhead only momentarily in particular geographical locations during certain seasons. To collect the sun's rays throughout the daylight hours, either the position of heater 10 is moved to track the position of the sun or a heliostat is used to cause the sun's rays to be reflected vertically. A heliostat embodiment he is shown in FIG. 4. Parallel solar rays 78 are arriving at an angle displaced from vertical. A mirror 82 is provided which reflect the rays into a vertical column into solar concentrator 90. Mirror 82 is attached to a frame 84 via a geared system. The angle of mirror 82 moves with respect to a pivot point 89 when a small gear motor 85 rotates. Teeth of small gear motor 85 engage with a gear 87 coupled to mirror 82. A motor 88 also attached to frame 84 causes the heliostat to rotate with respect to the centerline of motor 88. Heliostat 80 is one example of suitable arrangements for directing the sun's rays to a stationary heater. Frame 84 and motor 88 are shown just below solar concentrator 90. However, depending on the embodiment, frame 84 and motor 88 are displaced from the bottom of solar concentrator 90 to provide space for components associated with heater 10.

In one embodiment, mirror 82 can be tilted horizontally to protect heater 10 during night time hours when no solar energy is available. Furthermore, mirror 82 reflects any radiated energy from or through window 32 back to window 32 to at least partially prevent losses to the night sky.

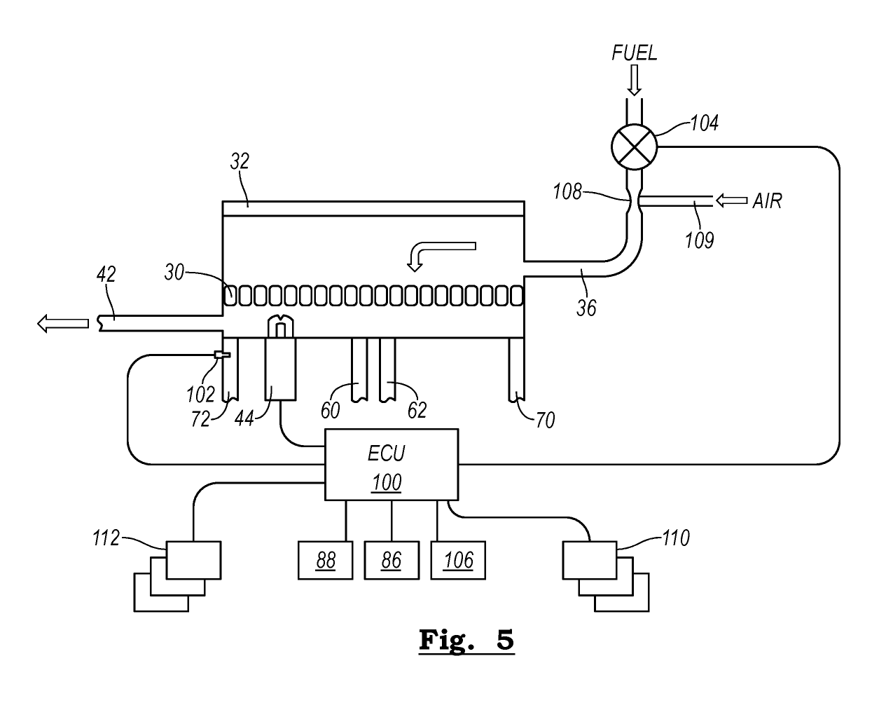

In FIG. 5, an electronic control unit (ECU) 100 and associated controllers and sensors are shown. ECU 100 receives input from a thermostatic control 106 or other suitable device to provide a signal to ECU 100 indicative of desired energy input. Outlet 72 of heat exchanger 30 has a thermocouple, thermistor, or other suitable temperature measuring sensor 102 disposed therein to provide to ECU 100 a measure of output temperature. Based on the results of temperature sensor 102 and/or based on other sensors 110 providing signals of conditions within the heater and/or the environment. The amount of pressurized gaseous fuel 104 is supplied to inlet 36 via a venturi 108 which pulls in air 109 in proportion to the fuel quantity. Fuel quantity is metered via a valve 104 with valve 104 commanded by ECU 100. The fuel/air metering arrangement in FIG. 5 is but one example for metering the fuel and air.

ECU 100 may also control motors 86 and 88 associated to heliostat 80 for embodiments including a heliostat. ECU 100 may also control other actuators 112 that might be associated with other aspects of the heat pump or heater. ECU 100 is shown as a single unit. However, in an alternative embodiment, the functions of ECU 100 are distributed among multiple controllers.

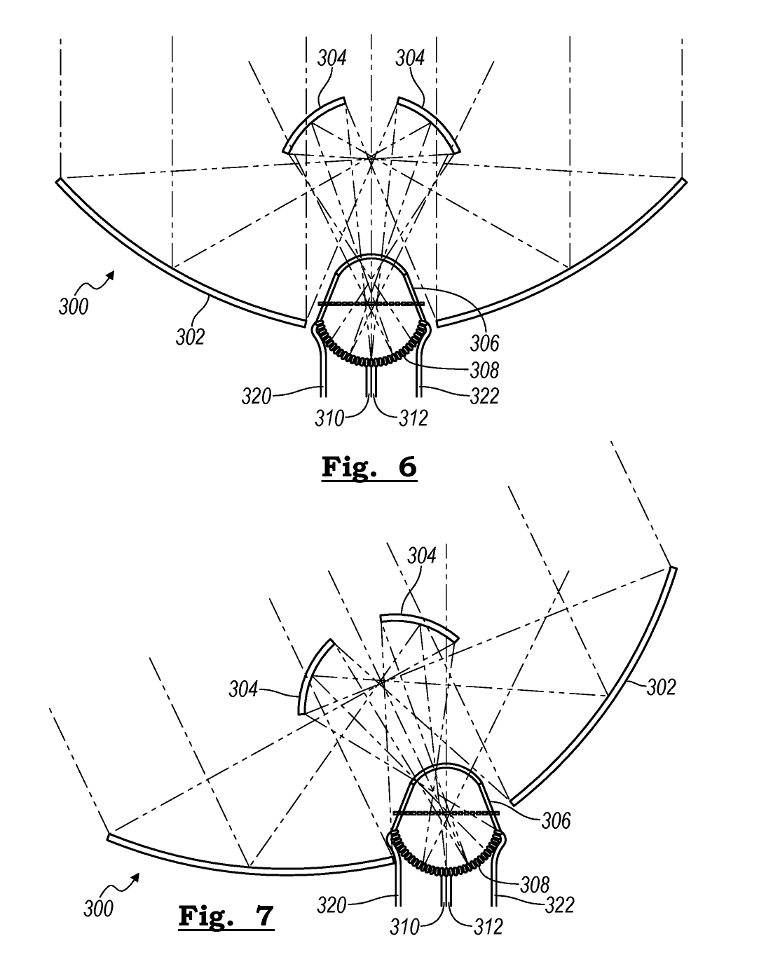

In FIG. 1, heater 10 has a nearly flat heat exchanger 30 and a nearly flat window 32 that are parallel to each other. In an alternative embodiment in FIG. 6, a solar concentrator 300 has parabolic mirror 302 and two parabolic mirrors 304 disposed above mirror 302. A domed window 306 is provided above heat exchanger 308. Parallel rays entering to mirror 302 nearly all cross the same point that is between and below parabolic mirrors 304. Rays are transmitted through window 306 onto a heat exchanger 308, which is dished. Working fluid is provided to heat exchanger 308 through inlets 310 and 312 and removed from heat exchanger 308 through outlets 320 and 322. An advantage of the embodiment in FIG. 6 is that only solar concentrator 300 is moved when tracking the sun. In FIG. 7, sun rays coming in at an angle are incident upon mirror 302 and directed onto one of mirrors 304 which direct the rays through window 306 onto heat exchanger 308.

In the embodiment in FIG. 1, either a heliostat is provided (such as the example shown in FIG. 4) or the entire heater moves to obtain a favorable position with respect to the sun. If the entire heater is moved in relation to the sun, flexible tubing is provided at locations in which a fluid leaves the apparatus. The heater in FIG. 1 is advantageous in using a flat window and a flat heat exchanger. The embodiment in FIGS. 6 and 7 is advantageous in that only solar concentrator 300 is moved to track the sun. However, window 306 and heat exchanger 308 are of a more complicated shape.

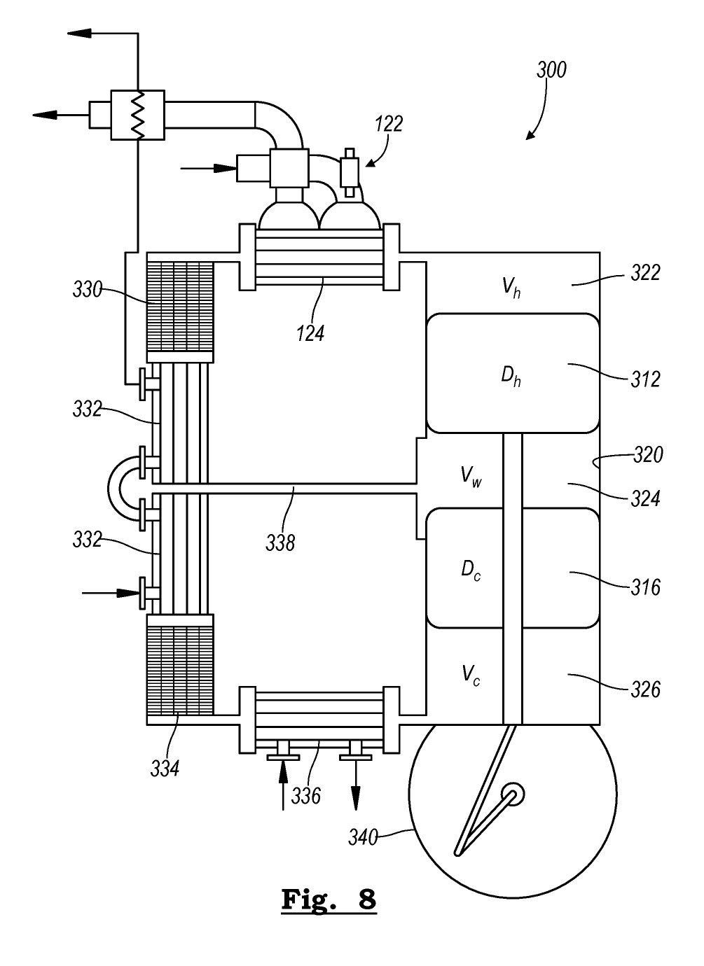

An example of a Vuilleumier heat pump 300 is shown in FIG. 8. Two displacers, hot displacer 312 and cold displacer 316 are provided in a cylinder 320 having a working fluid therein to thereby define three chambers: a hot chamber 322, a warm chamber 324, and a cold chamber 326. Displacers 312 and 316 reciprocate within cylinder 320 to change the volume of working fluid contained in chambers 322, 324, and 326. E.g., when hot displacer 312 is an extreme position towards hot chamber 322, most of the fluid is pushed out of hot chamber 322, through a hot heat exchanger 328. Hot heat exchanger 328 is coupled to a burner 122 that is supplied fuel and air. The fluid travels next through a hot recuperator 330, a warm heat exchanger 332, a cold recuperator 334, and a cold heat exchanger 336. Elements 328, 330, 332, 334, and 336 are fluidly coupled to cylinder 320 and having a passage 338 between warm heat exchanger 332 and warm chamber 324. Movement of displacers 312 and 316 are synchronized via crank 340 in a substantially sinusoidal fashion. In commonly-assigned U.S. Pat. No. 9,677,794 (which is incorporated herein by reference in its entirety), a heat pump is disclosed in which the displacers are mechatronically actuated. In the heat pump in FIG. 8 or that shown in U.S. Pat. No. 9,677,794, movement of the displacers causes working fluid to flow through heat exchangers 332, 336,

In FIG. 8, a Vuilleumier heat pump 120 is shown that has a burner 122 and a heat exchanger 124. (FIG. 8 is described in more detail in U.S. application 61/622,547 which is incorporated herein by reference in its entirety.) In place of burner 122 shown in FIG. 8, heater 10 of FIG. 1 is provided. In another alternative, a Vuilleumier heat pump in which the displacers are electromagnetically actuated, as disclosed in U.S. application 61/622,547, is coupled with the burner of FIG. 1 of the present disclosure.

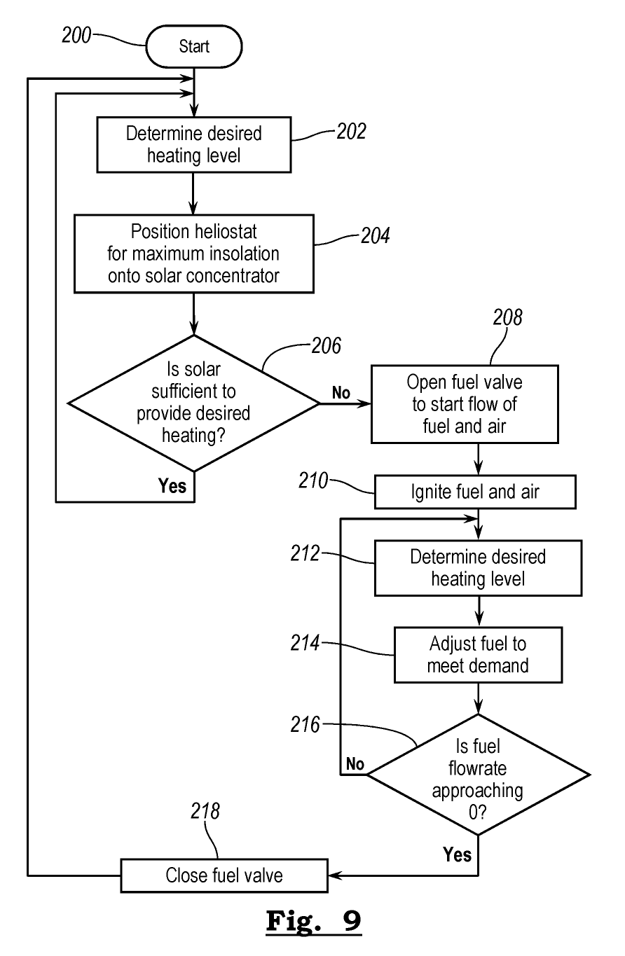

In FIG. 9, a control system according to one embodiment of the disclosure starts at 200. In block 202, the amount of heating desired is determined. In block 204, the heliostat is positioned so that maximum insolation is directed on the solar concentrator. In embodiments in which the entire heater is moved to collect the sun, instead of positioning the heliostat, the heater, in particular the solar concentrator, is positioned to provide the maximum insolation onto the heat exchanger. In block 206, it is determined whether the available solar insolation is sufficient to provide the desired heating. If so, control returns to block 202. If not, the burner is started beginning in block 208 in which the fuel valve is opened to provide fuel into the fuel-and-air delivery chamber. The fuel and air are drawn into the exhaust chamber through the heat exchanger. The ignitor is commanded to ignite the fuel and air in the exhaust chamber in block 210. The desired heating rate is determined in block 212. The fuel flow rate supplied is adjusted in block 214 to meet the present demand. Energy released via combustion supplements the solar energy that is received. Control passes to block 214 in which it is determined whether the fuel is substantially zero. If not, control returns back to block 212 to determine the present demand level. If a positive result in block 216, control passes to block 218 in which the fuel valve is closed to discontinue flow of fuel and air. Control returns to block 202.

As described above, the solar collection system is arranged so as to provide the maximum insolation. However, there could be situations in which the amount of energy provided through the sun's energy is greater than that needed for the heating or cooling demand, the heliostat or solar collector can be adjusted to provide less than the maximum insolation, i.e., when the demand is less than the available solar energy.

While the best mode has been described in detail with respect to particular embodiments, those familiar with the art will recognize various alternative designs and embodiments within the scope of the following claims. While various embodiments may have been described as providing advantages or being preferred over other embodiments with respect to one or more desired characteristics, as one skilled in the art is aware, one or more characteristics may be compromised to achieve desired system attributes, which depend on the specific application and implementation. These attributes include, but are not limited to: cost, strength, durability, life cycle cost, marketability, appearance, packaging, size, serviceability, weight, manufacturability, ease of assembly, etc. The embodiments described herein that are characterized as less desirable than other embodiments or prior art implementations with respect to one or more characteristics are not outside the scope of the disclosure and may be desirable for particular applications.

We claim:

1. A heater assembly, comprising:
a window having an outer surface and an inner surface;
a solar concentrator having a collection area many times greater than an area of the window wherein most of the incident solar radiation that impacts the solar concentrator are reflected onto the outer surface of the window;
a chamber defined by the inner surface of the window, a side wall and a bottom wall;
a heat exchanger disposed in the chamber, the heat exchanger dividing the chamber into a fuel-and-air delivery chamber and an exhaust chamber;
wherein:
the heat exchanger comprises at least one tube with a working fluid disposed within the tube; and
fuel and air provided to the fuel-and-air delivery chamber participate in an exothermic reaction near the surface of the heat exchanger;
exhaust from the exothermic reaction exits the exhaust chamber.

2. The assembly of claim 1 wherein the at least one tube of the heat exchanger is arranged in a spiral with a distance between adjacent tubes less than or equal to a predetermined gap.

3. The assembly of claim 1, further comprising: an ignitor with a tip of the ignitor disposed in the exhaust chamber.

4. The assembly of claim 3, further comprising:
a fuel supply duct coupled to an inlet of the fuel-and-air delivery chamber;
an air supply duct coupled to the inlet of the fuel-and-air delivery chamber;
a fuel valve disposed in the fuel supply duct; and
an electronic control unit electronically coupled to the fuel valve and the ignitor.

5. The assembly of claim 4 wherein the at least one tube of the heat exchanger is arranged in a spiral; and the tube has an inlet and an outlet, the assembly further comprising: a temperature-measuring device disposed in the outlet of the tube.

6. The assembly of claim 5, further comprising: an electronic control unit (ECU) electronically coupled to the temperature-measuring device and the fuel valve wherein the ECU controls the fuel valve based on the temperature at the outlet of the tube.

7. The assembly of claim 1 wherein the window and the heat exchanger are substantially flat and parallel to each other.

8. The assembly of claim 1 wherein the solar concentrator comprises:
a concave reflective parabolic ring adapted to reflect incoming solar rays onto the window;
a convex reflective parabolic disk disposed opposite the upper surface of the window; and
a concave reflective parabolic bowl disposed inside the reflective parabolic ring wherein the parabolic bowl is adapted to reflect incoming solar rays onto the parabolic disk and the parabolic disk is adapted to reflect incoming solar rays from the parabolic bowl onto the window.

9. The assembly of claim 1 wherein the solar concentrator is substantially parabolic, the assembly further comprising:
a positioning system to move one of: a mirror of a heliostat, the solar concentrator, and the heater assembly so that available rays from the sun are directed into the solar concentrator substantially parallel to a central axis of the solar concentrator; and
an electronic control unit electronically coupled to the positioning system.

10. A heater assembly, comprising:
a solar concentrator;
a chamber having a window; and
a heat exchanger disposed within the chamber, wherein:
a majority of solar radiation incident on the solar concentrator is reflected onto a surface of the heat exchanger;
the heat exchanger is comprised of at least one tube with a working fluid passing therethrough;
the heat exchanger divides the chamber into a fuel-and-air delivery chamber and an exhaust chamber;
fuel and air are provided to the fuel-and-air delivery chamber and then to the heat exchanger; and
the fuel and air react in the proximity of the heat exchanger to form exhaust products.

11. The assembly of claim 10 wherein:
the at least one tube of the heat exchanger is wound into a spiral with adjacent tubes of the spiral having a gap therebetween of less than a predetermined distance; and
the window is arranged substantially parallel to the spiral of the heat exchanger

12. The assembly of claim 11 wherein:
the fuel-and-air delivery chamber defines a fuel-and-air inlet;
the exhaust chamber defines an exhaust outlet; and
the exhaust chamber has a tip of an ignitor disposed therein.

13. The assembly of claim 10, wherein the at least one tube comprises:
a first tube arranged in a first spiral with an inlet at the center of the first spiral and an outlet at the periphery of the first spiral;
a second tube arranged in a second spiral with an inlet at the center of the second spiral and an outlet at the periphery of the second spiral;
the first and second spirals are entwined with a distance between adjacent tubes being less than a quench distance of the fuel and air; and
the outlets of the first and second tubes are arranged substantially diametrically opposed from each other.

14. The assembly of claim 10 wherein the at least one tube comprises a plurality of tubes with a distance between adjacent tubes being less than a quench distance of the combustible fuel and air.

15. The assembly of claim 10 wherein the solar concentrator is substantially parabolic, the assembly further comprising:
a positioning system to move one of: a mirror of a heliostat, the solar concentrator, and the heater assembly so that available rays from the sun are directed into the solar concentrator substantially parallel to a central axis of the solar concentrator;
a fuel delivery system having a valve to meter an amount of fuel provided to the fuel-and-air delivery chamber;
an air delivery system for metering air provided to the fuel-and-air delivery chamber; and
an electronic control unit electronically coupled to the valve, the ignitor, and the positioning system.

16. A heater assembly, comprising:
a chamber;
a heat exchanger disposed in the chamber, the heat exchanger comprising a tube having multiple bends with adjacent sections of the tube having a gap therebetween of less than a predetermined width wherein:
a working fluid flows within the tube of the heat exchanger;
an outer surface of the tube of the heat exchanger is provided energy by incident solar radiation;
the outer surface of the tube of the heat exchanger is provided at least two reactants;
the at least two reactants react proximate gaps between adjacent sections of the tube of the heat exchanger; and
the reaction between the two reactants is an exothermic reaction liberating thermal energy.

17. The heater assembly of claim 16 wherein the at least two reactants comprise air and a hydrocarbon fuel.

18. The heater assembly of claim 16 wherein the chamber is divided into a fuel-and-air delivery chamber and an exhaust chamber by the heat exchanger.

19. The heater assembly of claim 16 wherein one surface of the chamber comprises a window through with solar radiation enters the chamber to reach the heat exchanger.

20. The heater assembly of claim 16 wherein the predetermined width is a quench distance of the two reactants.
